(19) United States
(12) Patent Application Publication
(10) Pub. No.: US 2003/0067451 A1
(43) Pub. Date: Apr. 10, 2003

(54) CAPACITIVE TOUCH DETECTORS

(76) Inventors: JAMES PETER TAGG, CAMBRIDGE, MA (US); ALISTAIR JAMES CAMPBELL, CAMBRIDGE, MA (US)

Correspondence Address: Joseph B. Lerch, Darby & Darby P.C., 805 Third Avenue, New York, NY, 10022, US

(21) Appl. No.: 08/836,420

(22) PCT Filed: Nov. 14, 1995
(86) PCT No.: PCT/GB95/02678

(30) Foreign Application Priority Data
Nov. 14, 1994 (GB) 94 22 911.9

(51) Int. Cl. G09G 5/00

(52) U.S. Cl. 345/174

(57) ABSTRACT

A capacitive touch detector comprises means to improve selectivity—a narrow band buffer. Means for reducing the effect of noise comprise capacitive coupling of the buffer into the detector, which comprises a plurality of sensor pads of different inherent capacitances and means to approximate impedances which include said capacitances and are adapted to operate at respective frequencies to approximate the impedances. At least two multiplexers are arranged in series to lower capacitance loading of the sensor pads. A synchronous demodulator is arranged to be connected as a tracking filter to track the frequency of a capacitance-measuring signal from one to another of the sensor pads, possibly during a scan thereof.

A controller is connected to a number of pads or capacitive sensing zones by way of buffered multiplexer chips and, shielded connectors and cables. The buffered multiplexer chips can be cascaded in series or wired in parallel and are driven from a level translator which can in its simplest form comprise a resistor and capacitor network but should preferably comprise active elements. This ensures that the base voltage on (the voltage first applied in a halfwave to) a sensor pad is also applied to its shield and various parts (e.g. power supply rails, control port, chip substrate) of its associated multiplexer/s. The signals derived from this electronic scanning array are then further processed by a signal processor incorporating a microprocessor. The improvements relate to obtaining and processing the signal both in the analogue and digital domains and allow more reliable touch detection, including interpolation methods.

### FIELD OF THE INVENTION

The present invention relates to capacitive touch operated devices.

### BACKGROUND TO THE INVENTION

There has been general satisfaction with what has been provided heretofore in this field. However, we, as inventors of the present invention, have done considerable research and determined that there are a number of areas in which there could be substantial improvement. We have isolated the following areas in particular.

1 Sensitivity to radio interference

2 Sensitivity to static impulses

3 The inability to distinguish a large touch object at a great distance from a small touch object at a small distance. (For example, to distinguish the tip of a finger from the bulk of a human hand—known hereafter as the palm effect.

4 A generally low signal to noise ratio in the fundamental sensing, which tends to exhibit itself as slow response to a touch.

5 An inability to synthesise information from multiple sensors.

A previous patent (Bach: GB 2,250,822 B=WO 90/14604) has described a method of creating a buffered sensor utilising a frequency variable Schmitt trigger based oscillator. This arrangement has certain advantages in its simplicity of construction but we have appreciated that it suffers from oscillator lockup if presented with interference near its frequency or operation (i.e. it locks on to the interfering frequency), and that filtering is difficult to implement as the device works on a wideband FM principle and its operating range is between 100 KHz and 500 KHz.

A previous patent (Pepper: U.S. Pat. No. 4,371,746) relates to a sensing surface and an adjacent buffered surface detecting a touch through a thin insulating layer of glass. This adjacent buffer driven in sympathy with the signal of interest has many advantages particularly when used to scan arrays of sensors.

These two patents relate to improvements in construction, electronic sensor technology, the algorithms employed in determining touch and some novel arrangements of sensors to create new forms of touch-operated media capable of being used in a variety of applications.

A previous patent (Bach: GB 2,25,720 B=WO 92/08947) relates to a device for determining the presence and/or characteristics of an object or substance, and comprises capacitive means the capacitance of which is changed due to the presence and/or characteristic of the object or substance. The device also includes a circuit arrangement for detecting the change in capacitance, which includes a fixed frequency oscillator, the amplitude, output and/or phase of which is dependent on the change in capacitance.

An application for a UK patent (Applicant, Moonstone Technology Ltd; Inventor, Tagg: GB 9410281.1 on 20 May 1994, published number *) has been made relating to a through glass audio device which can be used in conjunction with these improvements to generate an information system with audio and tactile feedback.

The disclosure of the aforementioned patents and applications provides applications of, all possible combinations of features thereof with, and background explanation for, the present invention, and is accordingly hereby imported into the present specification.

Capacitive sensors can be constructed using the technology described by patent 2,250,822 B. However we have appreciated that these proposals suffer from a number of problems: particularly, static sensitivity and frequency lockup. Furthermore, we have appreciated that a means of multiplexing a number of channels is required without the multiplexing element reducing the sensitivity of the channel by loading it. Previous patent applications have described a way of organising a set of buffered multiplexers but we have appreciated that these proposals suffer from a number of inherent flaws including limited fan out (ability to drive many sensor pads or make connections thereto) and the incorrect driving of multiplexer chips which results in inconsistent performance from one component to the next. These effects are particularly pronounced when large pads need to be driven at the end of long, high capacitance wires.

The aforementioned documents do not refer to the actual action of touching. The prior patent documents cited, U.S. Pat. Nos. 5,172,065, 5,214,388 and EP-A-0428502, refer to proximity sensors which are not suitable for detecting a touch per se.

The Present Invention

According to respective aspects of the present invention, there are provided detectors having the respective features defined in the accompanying claims and in following Points 1-32:

1. A capacitive touch detector, which comprises means to improve selectivity.

2. A detector, which comprises a narrow band buffer.

3. A detector, wherein means for reducing the effect of noise comprise capacitive coupling of the buffer into the detector.

4. A detector, which comprises a plurality of sensor pads of different inherent capacitances and means to approximate impedances which include said capacitances.

5. A detector, which comprises circuitry comprising said impedances and adapted to operate at respective frequencies to approximate the impedances.

6. A detector, wherein said impedances comprise components having respective resistances to approximate the impedances.

7. A detector, which comprises a plurality of sensor pads and at least two multiplexers arranged in series to lower capacitance loading of the sensor pads.

8. A detector, which comprises a plurality of sensor pads and a synchronous demodulator arranged to be connected as a tracking filter to track the frequency of a capacitance-measuring signal from one to another of the sensor pads, possibly during a scan thereof.

9. A detector, which comprises, means to improve the selectivity of capacitances taken into account to determine touch detection.

10. A detector, which comprises a multiplexer and a buffer and means adapted to connect part of the multiplexer other than its channels to an output of the buffer.

11. A detector, wherein said multiplexer part comprises power supply rails of the multiplexer.

12. A detector, wherein said multiplexer part comprises a control port of the multiplexer.

13. A detector, wherein said multiplexer part comprises a chip substrate of the multiplexer.

14. A detector, which comprises a sensor pad, a shield for the sensor pad and means to apply a frequency signal to the sensor pad for touch detection and apply to the shield a signal of substantially the same frequency, amplitude, phase and shape as the said frequency signal.

15. A detector, wherein the shield signal applying means are adapted not to control the d.c. level of the signal applied to the shield.

16. A detector, which comprises a sensor pad and means to charge the sensor pad and measure its charging rate.

17. A detector, wherein the charging and measuring means are adapted to charge the sensor pad with a constant current for a fixed time and measure the voltage achieved.

18. A detector, which comprises means to recognise a time profile of capacitance change indicative of a touch to be detected.

19. A detector, which comprises means to detect a snap effect in a time profile of capacitance change indicative of a touch to be detected.

20. A detector, which comprises means to enhance a time profile of capacitance change indicative of a touch to be detected.

21. A detector, wherein said enhancing means comprise means adapted to enhance a snap portion of said profile.

22. A detector, wherein said enhancing means comprise means adapted to correct a base line of said profile.

23. A detector, wherein said enhancing means comprise means adapted to correct the maximum amplitude of said profile.

24. A detector, which comprises means to provide an adaptive pattern match to a time profile of capacitance change indicative of a touch to be detected.

25. A detector, which comprises sensor pads and means which, upon the occurrence of signals indicative of such detection from a plurality of the sensor pads, produce a signal indicative of a touch position among the sensor pads.

26. A detector, which comprises means for serially scanning said sensor pads to obtain said signals indicative of touch detection.

27. A detector, which comprises means for normalising said signals indicative of touch detection and adding the normalised signals to obtain said signal indicative of a touch position.

28. A detector, which comprises means for palm rejection.

29. A detector, which comprises means for interpolation from an array of activated sensory elements to determine a mean position of touch.

30. A detector, wherein the interpolation means are effectively self-calibrating.

31. A detector, wherein the interpolation means are adapted to effect interpolation by a geometrical method.

32. A capacitive detector, which is adapted to detect a touch, i.e. an action of actually touching.

More particularly, there may be provided detectors having the features defined in any of the following Points 1-33:

1. A detector, which comprises a plurality of said accumulators and is adapted to ensure that if the value in one of the accumulators is greater than a predetermined level when it is reset to zero and it is the biggest accumulated value at that time among the accumulators then a touch down indication is produced, otherwise all accumulators continue to accumulate as before.

2. A detector, which is adapted to ensure that if a second slightly higher threshold than said predetermined level is exceeded then said increments are weighted more greatly.

3. A detector, which comprises a narrow band buffer.

4. A detector, which comprises means for reducing the effect of noise which comprise capacitive coupling of the buffer into the detector.

5. A detector, which comprises a plurality of sensor pads of different inherent capacitances and means to approximate impedances which include said capacitances

6. A detector, which comprises circuitry comprising said impedances and adapted to operate at respective frequencies to approximate the impedances.

7. A detector, wherein said impedances comprise components having respective resistances to approximate the impedances.

8. A detector, which comprise a plurality of sensor pads and at least two multiplexers arranged in series to lower capacitance loading of the sensor pads.

9. A detector, which comprises a plurality of sensor pads and a synchronous demodulator arranged to be connected as a tracking filter to track the frequency of a capacitance-measuring signal from one to another of the sensor pads, e.g. during a scan thereof.

10. A detector, which comprises means to improve the selectivity of capacitances taken into account to determine touch detention.

11. A detector, which comprises a multiplexer and a buffer and means adapted to connect part of the multiplexer other than its channels to an output of the buffer.

12. A detector, wherein said multiplexer part comprises power supply rails of the multiplexer.

13. A detector, wherein said multiplexer part comprises a control port of the multiplexer.

14. A detector, wherein said multiplexer part comprises a chip substrate of the multiplexer.

15. A detector, which comprises a sensor pad, a shield for the sensor pad and means to apply a frequency signal to the sensor pad for touch detection and apply to the shield a signal of substantially the same frequency, amplitude, phase and shape as the said frequency signal.

16. A detector, wherein the shield signal applying means are adapted not to control the d.c. level of the signal applied to the shield.

17. A detector, which comprises a sensor pad and means to charge the sensor pad and measure its charging rate.

18. A detector, wherein the charging and measuring means are adapted to charge the sensor pad with a constant current for a fixed time and measure the voltage achieved.

19. A detector, which comprises means to recognise a time profile of capacitance change indicative of a touch to be detected.

20. A detector, which comprises means to detect a snap effect in a time profile of capacitance change indicative of a touch to be detected.

21. A detector, which comprises means to enhance a time profile of capacitance change indicative of a touch to be detected.

22. A detector, wherein said enhancing means comprise means adapted to enhance a snap portion of said profile.

23. A detector, wherein said enhancing means comprise means adapted to correct a base line of said profile.

24. A detector, wherein said enhancing means comprise means adapted to correct the maximum amplitude of said profile.

25. A detector, which comprises means to provide an adaptive pattern match to a time profile of capacitance change indicative of a touch to be detected.

26. A detector, which comprises sensor pads and means which, upon the occurrence of signals indicative of touch detection from a plurality of the sensor pads, produce a signal indicative of a touch position among the sensor pads.

27. A detector, which comprises means for serially scanning said sensor pads to obtain said signals indicative of touch detection.

28. A detector, which comprises means for normalising said signals indicative of touch detection and adding the normalised signals to obtain said signal indicative of a touch position.

29. A detector, which comprises means for palm rejection.

30. A detector, which comprises means for interpolation from an array of activated sensor elements to determine a mean position of touch.

31. A detector, wherein the interpolation means are effectively self-calibrating.

32. A detector, wherein the interpolation means are adapted to effect interpolation by a geometrical method.

The words “sensor” and “detector” are used interchangeably herein.

According to an aspect of the invention a controller is connected to a number of pads or capacitive sensing zones by way of buffered multiplexer chips and, shielded connectors and cables. The buffered multiplexer chips can be cascaded in series or wired in parallel and are driven from a level translator which can in its simplest form comprise a resistor and capacitor network but should preferably comprise active elements. This ensures that the base voltage on (the voltage first applied in a halfwave to) a sensor pad is also applied to its shield and various parts (e.g. power supply rails, control port, chip substrate) of its associated multiplexer/s. The signals derived from this electronic scanning array are then further processed by a signal processor incorporating a microprocessor. The improvements made which constitute this invention relate to obtaining and processing the signal both in the analogue and digital domains which allow more reliable touch detection.

With prior keypads, each comprising an array of sensor pads, each sensor pad is capable of detecting the proximity of a finger in a continuously increasing manner, starting from say one inch (2 cm) away all the way up to contact. For use as a keypad we currently set a simple “threshold level” so that when the finger is closer than a certain point a key-press is indicated. However, we also can use the detailed information from several sensor areas simultaneously to “interpolate” the position of a finger in two or three dimensions to a much finer resolution than, say, a 4×4 sensor pad matrix in a keypad. This is done in a digital manner but could be done in an analogue manner.

There are a number of sensor array patterns which lend themselves to providing the opportunity to interpolate additional resolution between sensor pads. These fall into three main categories.

1. Single surface arrays of pads printed on one sensing layer where the pattern is fundamentally symmetrical. For example, square arrays of pads or hexagonal arrays of circles.

2. As above but where the array is asymmetrical such as the ‘Backgammon grid’.

3. Dual surface sensors where two orthogonal arrays are printed on two different layers and sandwiched together. The top layer must provide gaps through which the bottom sensor can see. A preferred embodiment of a construction method for an orthogonal screen is described with the aid of diagrams in FIGS. 23-24.

We now describe the location geometry for a single surface symmetrical array.

Simplified location geometry. See FIG 8. Since xa (offset) and s (sensor spacing) are known, using simple Pythagorean law and solving for xf (finger position horizontally) we have

$$xf = \frac{{a}^{2} - {b}^{2} + {s}^{2}}{2 s} + xa$$

This form of calculation generalises into two dimensions. Using similar trigonometric principles, and assuming the thickness dimension z (of e.g. glass, dielectric constant 4, assumed normalised to the corresponding thickness of air, dielectric constant 1, by a factor of ¼) is a constant we have for instance:

$$yf = \frac{{a}^{2} - {b}^{2} + {s}^{2}}{2 s} + ya$$

For a hexagonal array, e.g. see FIG. 9,

$$xf = \frac{{a}^{2} - {b}^{2} + {s}^{2}}{2 s} cos {30}^{°} + xa$$

although this calculation can be done by several alternative methods.

However, things are not that simple. The sensor response is not, in fact, linear with distance. It follows a law approximating to

$$response = \frac{1}{{distance}^{n}} where 1 < n < 2$$

or in more practical terms this can be considered as follows. Interpolation of touch position for capacitive sensor pads can be improved by calibration, by normalising/equalizing the capacitance detected from each sensor pad and/or by utilising a (third) dimension angled (e.g. perpendicular) to the area containing the sensor pads. Capacitance is related to the distance between finger (tip) and sensor pad by a non-linear equation:

$$capacitance = {k}_{1} \frac{a}{d} + {k}_{2} \frac{a}{d} 2$$

where

a=effective area of finger and

d=distance from finger to sensor pad

and may be determined on calibration by creating a digital “look-up” table (corresponding to a graph) by using a standard “finger tip” (a plate). In the equation, the dimension a is the area of a flat plate having the same capacitance effect as the curved finger tip.

This is then further complicated by the glass/air interface and the fact that human fingers are not uniformly spherical metal objects—they are possessed of variable shape, cross-section and conductivity. The resulting non-linear equation can be used to linearise the position of the finger or in a microprocessor the relinearisation mapping can be stored as a lookup table in a digital memory, e.g. an EPROM or E²PROM, usually after calibration with a test “finger” (equivalent plate) in various positions when the keypad is in situ e.g. on a window.

A preferred embodiment of an interpolation method is described with the aid of FIG. 25, as applied to providing means for interpolation from an array of activated sensory elements (the said sensor pads).

Palm Rejection

The grid of row and column wires is affected dramatically by the touch of a finger due to the capacitive snap effect as air is excluded from under the finger tip. However the palm and knuckles, even though they are a considerable distance from the finger tip, are large and will have some effects on the rows and columns of the grid. Unfortunately due to the asymmetric nature of the human hand the palm is generally offset from the centre of the finger tip and therefore introduce an error in the calculated position.

In general, since the effect due to the finger tip is localised to two wires while the palm affects many wires at a distance a means of determining pain, offset can be found by using more wires in the grid.

A simple way of determining palm effect is look at the second adjacent wires i.e. two away from the most touched wire rather than one away from the most touched wire and calculating a linear interpolated position as described above. This method produces a new estimated point offset from the first adjacent point by an amount proportional to the palm effect. This offset can be multiplied by a known constant and used to correct the estimated position. In practice, this method suffers from noise as well as only being valid in the centre of the grid. There are however more generalisable solutions to this problem which are described below.

Firstly, a solution of simultaneous equations: In the linear interpolation problem above, two data points are used to find two unknowns namely m and c in a generalised y=mx+c description of a straight line. Once this straight line is known, a third data point x is introduced and solved for y. Increasing the number of unknowns by one, i.e. the palm offset, can be compensated for by increasing the number of data points and solving the appropriate simultaneous equations. Solving these in a general way on a small microprocessor is generally too time consuming.

Secondly, one general solution to the above problem is not time consuming: that is to find the weighted mean (centre of gravity) of all the wires in the grid. This weighted mean can then be scaled to represent a position on the grid. Since this weighted mean is calculated using all of the wires on the grid it will be more affected by the palm than a method using only two or three wires on the grid. The difference in estimated position between the two methods is then a function of the effect due to the palm and can be applied to the less affected measure of position to more accurately locate the point of touch.

$$weightedmean = \frac{\sum ( eachweight \times itsvalue )}{\sum ( eachvalue )}$$

A preferred embodiment is explained below with the aid of diagrams in relation to FIGS. 26 and 27.

Generalisation of the Above

Of course any part of the human anatomy or indeed any substance or object might be substituted for the human hand and these aforementioned methods applied to determine their position and or collision with a sensing plate.

The methods described in this specification for finding a position are usually described for the X dimension using the columns in an X,Y grid. It is clear that by substituting rows for columns the position in Y can be determined.

The description refers to a small (i.e. low cost) microprocessor but could be generalised to any form of digital logic, ASIC, neural network and so on, or a small portion of the duty cycle of a larger processing unit.

Advantages of Embodiments of the Invention

Because the shield is driven with a very high fidelity, long cables can be employed which have a high co-capacitance (between sensor pad and shield) without seriously degrading the signal.

Well shielded wires can be employed which reduced emission and susceptibility to electrical interference.

The buffering/bootstrapping of many parts of the multiplexer chip allows a large number of series or parallel multiplexers to be employed.

Reduced static sensitivity can be achieved by a number of signal processing techniques in both the analogue and digital domains. FIG. 5 shows some processing methods in the digital domain, while FIG. 30 shows some techniques to remove static sensitivity in the analogue domain.

Finally, techniques within the interpolation algorithm can be used to make the interpolation as a differential calculation that assists in the removal of common mode interference such as static impulses.

Reduced frequency lockup when a high voltage interfering signal is present, such as near a monitor, is accomplished by running the detector circuit at a frequency which is not harmonically related to that of the noise source.

A preferred embodiment of a dC/dT touch-down detection method, otherwise referred to as the ‘snap effect’ or the deltaT method, is described below with the aid of the diagrams in FIGS. 20-22.

The benefits of the deltaT method are:

It is relatively immune to the absolute starting and finishing capacitance values and so needs little calibration.

The touch point is generated by the change from the rapid increase in the capacitance of the finger as the soft tissues of the finger pad compress and slow speed of capacitance increase as the bony parts of the finger start to press. This change is similar for big and small hands and light and heavy touches, so the perceived touch point is similar for all users.

In relation to FIG. 25 there is described a method of linear interpolation for an orthogonal grid. The benefits of this method of linear interpolation are:

The interpolated position is derived by taking a proportion between two averages. Noise present on one line tends to be present on all lines. Therefore the proportional calculation being differential is immune to common mode noise.

The use of averages in the proportional calculation helps smooth out any random error.

The end points are defined by crossing points of actual data taken in real time rather than any pre-calibrated/stored value so variations in ambient conditions and the nature of the touch are taken into account in real time.

Important Dimensions:

In principle, pads can be of many different sizes and materials but it is important to bear certain fundamental physical limitations in mind with reference to pad size and cable length. This can be summarised in the general principle that the “obscuring” capacitance due to these must not outweigh that being measured and preferably should be much less. As disclosed herein, various means are used to back off or make ineffective such obscuring capacitance.

Important Dimensional Considerations for an Orthogonal Touch Screen are:

It is desirable to minimize the number of sensor zones but this would tend to force them to be as large as possible. However, if they are wider than approximately 2-3 average finger widths, interpolation data are seriously impaired as there ceases to be much change in data in the central region of the zone. Therefore, a sensing column designed to give information regarding the X position of a finger should be no wider than 30 mm. Its length can be the appropriate dimension to the viewing area.

The column and row areas should be separated by as small a distance as possible to reduce the shielding effect of one layer on another. However to small and the coupling capacitance between layers reduces independent orthogonal information. A separation of 0.25 min has been found to be optimal.

Applications of the Invention:

The aforementioned improvements can be applied to a number of areas including:

Capacitive pads connected to a controller by wire

Keypads

A major application of the invention is to a touch screen.

### DESCRIPTION OF THE DRAWINGS

The invention will now be further described by way of example with reference to the accompanying drawings, in which:

FIG. 1 is a diagram of touch pad arrangement embodying the invention;

FIG. 2 is a diagram of electronic arrangement embodying the invention;

FIG. 3 is a diagram of touch arrangement embodying the invention;

FIG. 4 is a diagram of snap “effect” of capacitive touch-down detection embodying the invention;

FIG. 5 is a diagram of a static reduction algorithm embodying the invention;

FIG. 6 is a diagram of transparent pad construction embodying the invention;

FIG. 7 is a diagram of multiple sensor detection embodying the invention;

FIG. 8 is a diagram of simplified location geometry embodying the invention and showing mathematics of multiple sensors;

FIG. 9 is a diagram of hexagon grid embodying the invention;

FIG. 10 is a diagram of orthogonal wires embodying the invention;

FIG. 11 is a diagram of geometry of hexagon grid embodying the invention;

FIG. 12 is a diagram of transparent pad connection to multiplexer embodying the invention;

FIG. 13 is a diagram or shielding effect of buffer embodying the invention;

FIG. 14 is a diagram of touch process embodying the invention;

FIG. 15 is a diagram of field around sensor pad embodying the invention;

FIG. 16 is a diagram of use of sensor pad embodying the invention;

FIG. 17 is a diagram of charge-discharge cycle of sensor pad embodying the invention;

FIG. 18 is a diagram of impedance-matching circuit embodying the invention;

FIG. 19 is a diagram of response path upon use of a touch detector embodying the invention;

FIG. 20 is a graph of the capacitances versus time seen by an array of sensing zones as a finger approaches and touches on one of the zones;

FIG. 21 is a as above but for the rate of change of capacitance;

FIG. 22 is a graph of the contents of the accumulators over time for the same touch as 21 & 20 above;

FIG. 23 is a general arrangement drawing for a touchscreen using orthogonal sensing elements on two surfaces;

FIG. 24 is a detail from one layer of the general arrangement drawing above;

FIG. 25 is a graph of the capacitance with time of a number of sensing zones as a finger is dragged across the screen;

FIGS. 26 and 27 are plan and elevation diagrams of a finger and hand showing palm rejection;

FIG. 28 is a diagram of a single surface asymmetrical sensor arrangement ‘backgammon grid’;

FIG. 29 is a drawing of an etch pattern more appropriate to the laser etching of glass sensors; and

FIG. 30 is a circuit diagram of the electronic components arranged around a buffer in order to reduce the effect of noise.

Referring now to the Figures, the numeral references are individual to each Figure, so that the same reference in two different Figures does not denote any relationship between the items so referred to, unless this is specifically so stated.

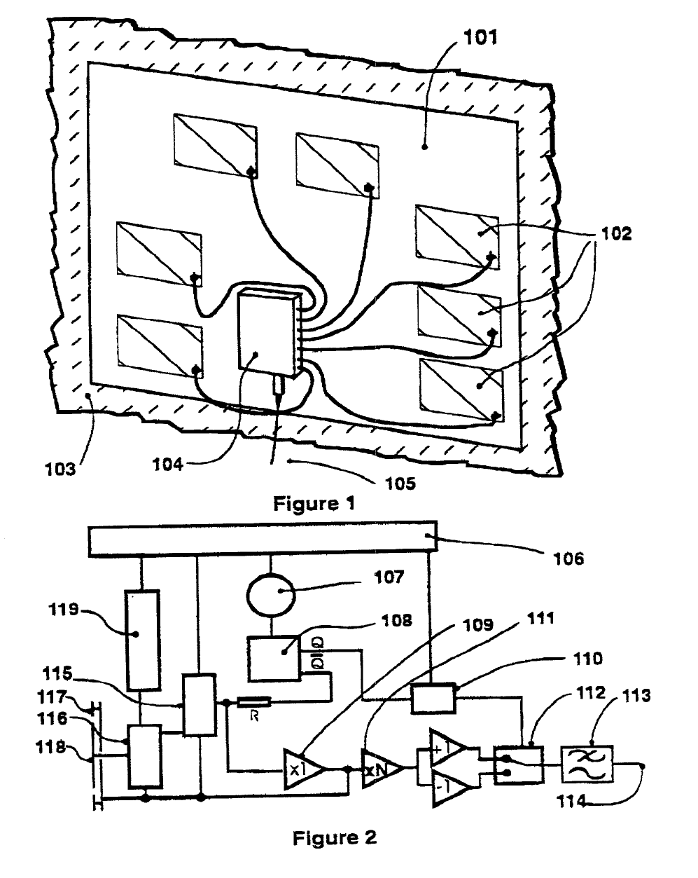

FIG. 1 shows a series of backlightable pads 102, placed behind display artwork 101, which is mounted in a shop window. When a person touches the outside of the window 103 the change in capacitance of the pad is detected by the controller 104 and a relayed to the computer by way of a serial link 105.

FIG. 2—shows the arrangement of the signal processing electronics. A control means 106 sets an oscillator 107 to oscillate at a frequency F. The frequency is fed to a Flip/flop 108 which divides the signal on alternate cycles thus generating a quadrature output. An optional phase delay 110 is introduced to the 90 degree signal. This matches the sensor RC circuit phase delay to optimise the synchronous demodulation. The original signal is connected to the sensor 118 via a high value resistor and one or more buffered multiplexers 115, 116. These multiplexers may be located in proximity to the control means or addressed via a remote logic 119. The squarewave frequency signal charges and discharges the plate through the high value resistor. The signal seen on the other side of the resistor is approximately a sine wave except that the finite frequency response of the buffer 109 rounds the ends so that an almost sinusoidal signal is actually present. As the capacitance of the plate increases the peak of the triangle/sine wave signal decreases in amplitude. A one to one buffer 109 returns this amplitude variable signal to a cojacent buffer thus removing unwanted stray capacitance from the measurements. The elements 111, 112, 113 form a standard synchronous demodulator which provides a demodulated output to a analogue to digital converter 114 which can be read by a microprocessor, not shown.

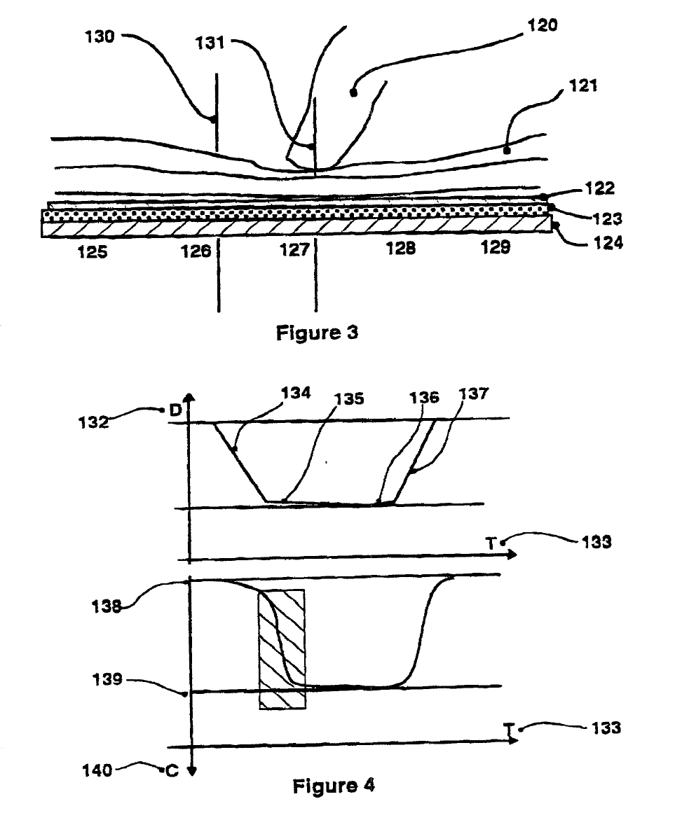

FIG. 3—shows in schematic form the equipment lines 121 formed when a earthed finger 120 approaches a sensor pad 122 in the presence of a cojacent buffer 124. An insulating layer of finite thickness 123 separates sensors from the cojacent buffer plane. The diagram represents the lines of equal voltage at a given moment in time T. The degree to which the lines are compressed gives a graphical indication to the capacitance seen by each pad. Each pad, at positions 125, 126, 127, 128, 129 is affected to some (usually different) degree by the finger placed at 131. A software algorithm can make use of the adjacent pads to interpret information about the size and shape of a touching object. For example in the case of a drawing application a user could, draw with their finger and rub out with the flat of their hand.

FIG. 4 shows a graph of two related variables: 132, 133, position/distance against time for a finger touching a hard surface and the capacitance of a sensor arrangement as it is touched by a finger. The normal capacitance of an untouched sensor rests at the baseline. Due to the buffer this baseline represents a very low capacitance. As the finger approaches the capacitance rises and due to the dielectric discontinuity at the glass the capacitance rises dramatically at the point of touch (giving the snap effect in the shaded region) as air is excluded from between the finger and the sensor and the finger flattens against the glass.

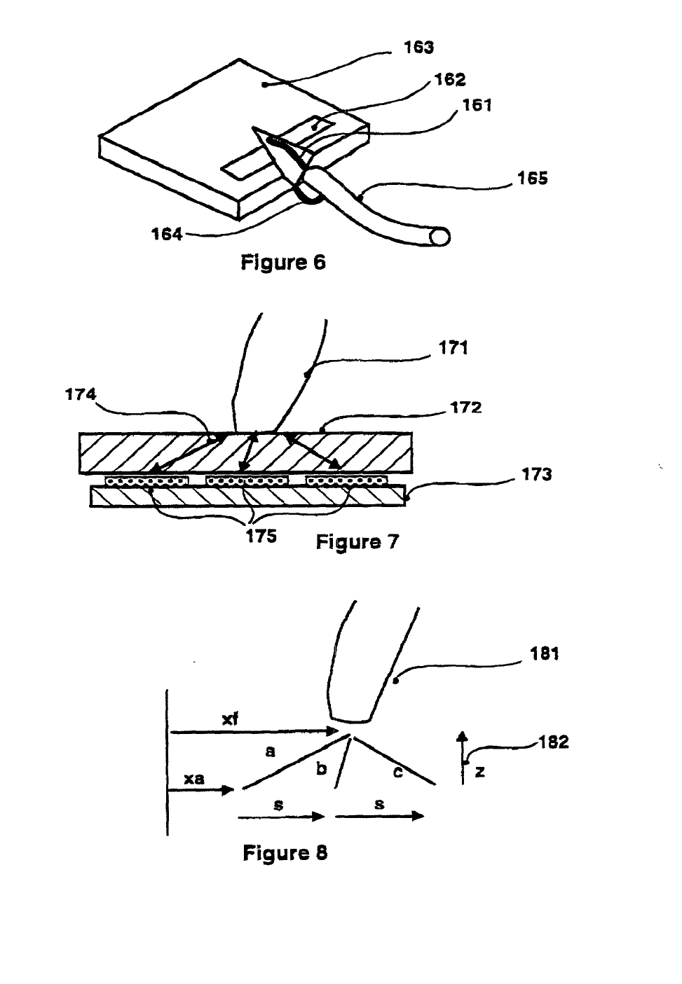

FIG. 6—shows a novel construction for a transparent backlightable pad. The pad itself is simply constructed from a single sheet of glass with transparent conductive surfaces on top and bottom 163. It is desired to connect a piece of coaxial cable 165 to the glass but at the same time making one surface completely flat so that it can be placed behind and uniformly pressed up against a piece of translucent artwork. In order to do this a small notch 161 into which the centre wire will be placed is cut in the top surface of the glass at the edge. A “frit” pattern 162 is deposited across this notch which comprises a small and extremely thin section of silver-loaded paint. A solder bond can then be made in the notch 161 such that it is not higher than the surface of the glass. A solder joint is made for the braid 164 to the rear in the same way but omitting the notch.

FIG. 7—shows schematically a finger about to touch a glass plate with a series of capacitive sensors on the underside. The distance between the finger and each sensor relates to the capacitance according to Gauss's law.

FIG. 8—The capacitive analogue of the distance between several sensors can be ascertained and converted to distances a, b and c. Using standard trigonometrical calculations the position of the finger in the x and y planes can be determined. These calculations easily translate to three dimensions.

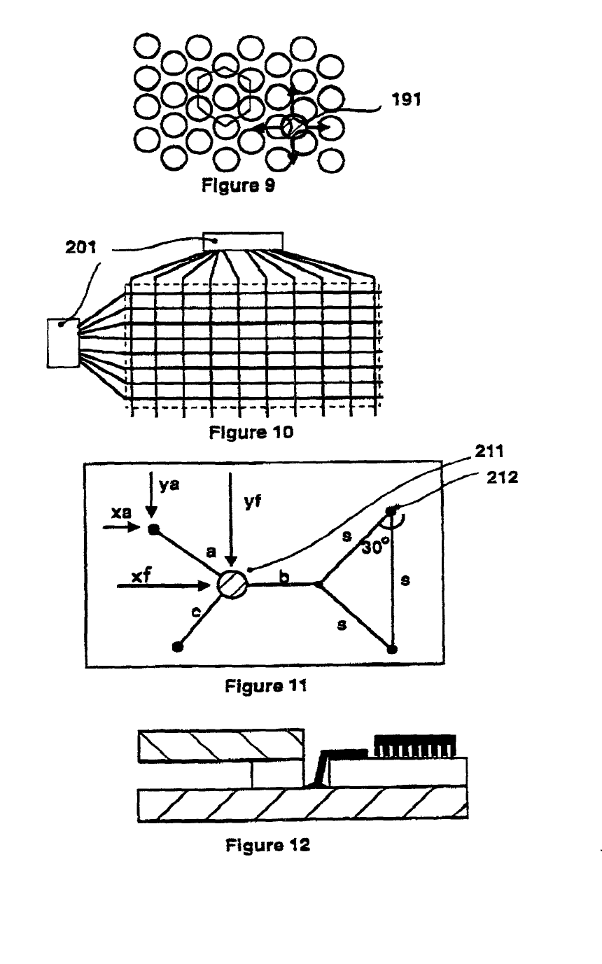

FIG. 9—shows one of many possible arrangements of sensing elements. In this case in a hexagonal pattern of sensors each sensor connection back to one of the channel of multiplexer input. Many other shapes are possible, for example, orthogonal patterns of squares or other shapes, crossing matrices of wires or any other three dimensional arrangement of sensors.

FIG. 10—shows an array of orthogonal wires. Each wire is independently addressable through a multiplexer arrangement. The capacitance of each wire changes in the presence of a finger giving an X and Y co-ordinate for the touch point. Due to the buffer the field from each wire is linearised and background capacitance is removed. The removal of this background capacitance is of benefit as the subsequent detection of the finger has a far greater effect on the wire and also establishes the snap characteristic of touch detection.

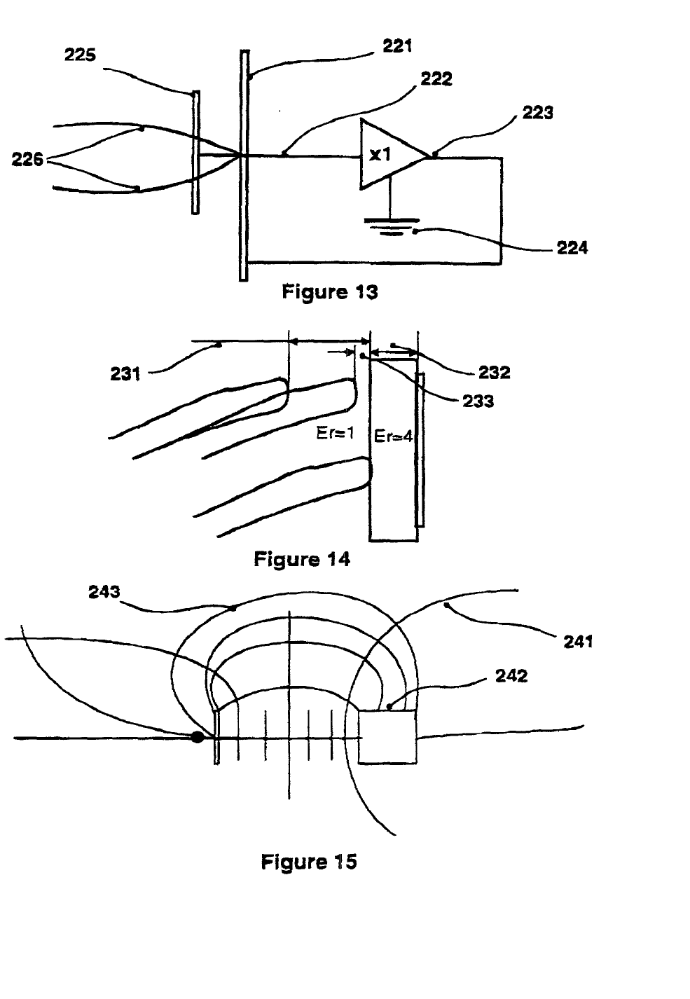

FIG. 13—The buffer has three shielding effects due to its low impedance output;

1. Because the buffer is interposed between the electronics and the sensor the sensor electronics are shielded against interference.

2. Because the buffer reduces the background capacitance the wanted signal is larger than the general noise within the circuit therefore circuit noise has less of an effect on the signal.

3. It is believed that RF interference impinging on the sensor plane is shorted to earth by the buffer plane and therefore the maximum excursions of noise on the sensor plane are limited.

The four contributors to the “Capacitive snap” effect:

1. The buffer increases overall sensitivity—subtracting the background capacitance.

2. The buffer increases local sensitivity by concentrating the field in a particular direction. However this effect is rather like a dipole as described in most physics books and at a great distance the sensor field spreads out uniformly.

See FIG. 14.

3. The dielectric discontinuity caused by the air glass interface and the fact that the dielectric of glass is approximately 4 times that of air means that as the touch is made and the final millimetre of air is excluded from the gap the capacitance rises dramatically. In the case of a 4 mm thickness of glass and a 1 mm air gap closing the last millimetre increases the capacitance by a factor of 2.

4. As the finger squashes on the glass the shape of the finger changes from that approximating a sphere to that approximating a flat plane. This causes the capacitance to rise by another factor of 2.

So, for objects a long way from the sensor (>10 diameters of “lumped” sensor pad or longer than the linear dimension of a wire), the buffer field effectively wraps round and shields the sensor.

For objects close to the sensor for an apparent movement of 1 mm the capacitance has risen by a factor of approximately 4.

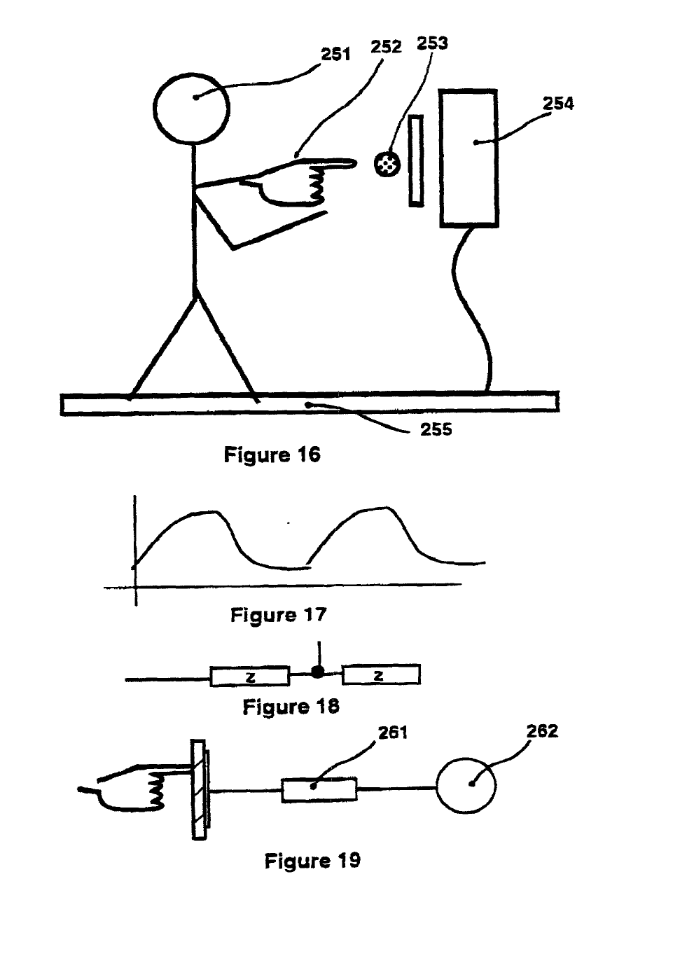

See FIGS. 15 and 16.

A key difference between the GB 2,250,822 patent and this application relates to the use of different (but not variable) frequencies for each key. The impedance of the high value register and the impedance of the capacitor formed by one's hand and the glass need to the approximately equal for optimum touch detection. Since the impedance of a capacitor is frequency variable changing the frequency balances these two impedances.

See FIGS. 17, 18, 19.

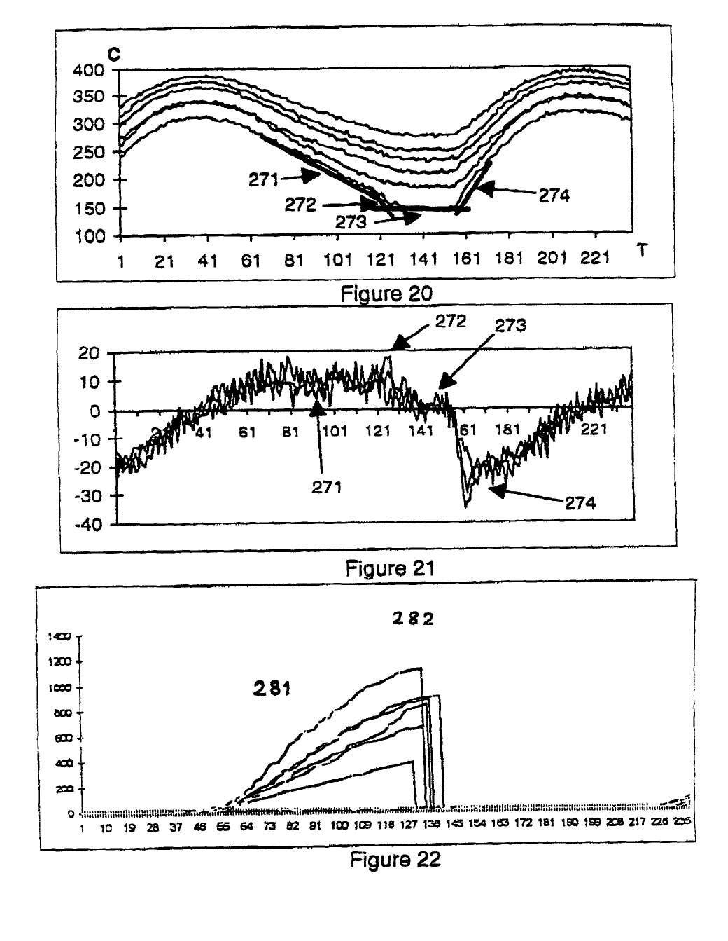

FIG. 20 shows a graph of a very slow touch. The X axis shows capacitance with low numbers indicating higher capacitance and the Y axis shows time where each unit represents a time interval of approximately 12 mS in which 16 elements are scanned sequentially. The lines on the graph represent the output of two sets of 8 scanning elements arranged orthogonally as described in relation to FIG. 10 being scanned in quick succession. The graph is split into 3 portions 271, 273 & 274. Portion 271 is the slow approach of the finger. Portion 274 represents the part of touch after the finger has touched down. Note the sudden change of slope between portions 271 & 273 which is the capacitive snap as the air is excluded from between fingertip and glass. The final portion 274 is the release of the finger. The most affected element and second most affected in the array are signified by the two lowest lines measured in the mid portion of the graph 272. These two lines represent the X and Y sensing elements respectively. If touching on an intersection of two XY grids, these lines will be coincident, or almost so. However, if one line (e.g. X) is touched dead centre and one line (e.g Y) is touched off centre, then the dead centre line will be affected the most. This proportionality of effect is used to provide interpolation as explained later.

FIG. 21 shows the rate of change of capacitance with time, dC/dT on the same time scale as FIG. 20. The numeral references correspond to those described above for FIG. 20. It can be seen from this graph that simply attempting to locate the maximum rate of change indicated by the capacitive snap effect is not a very successful way of detecting touch down as the noise almost swamps any absolute measurements.

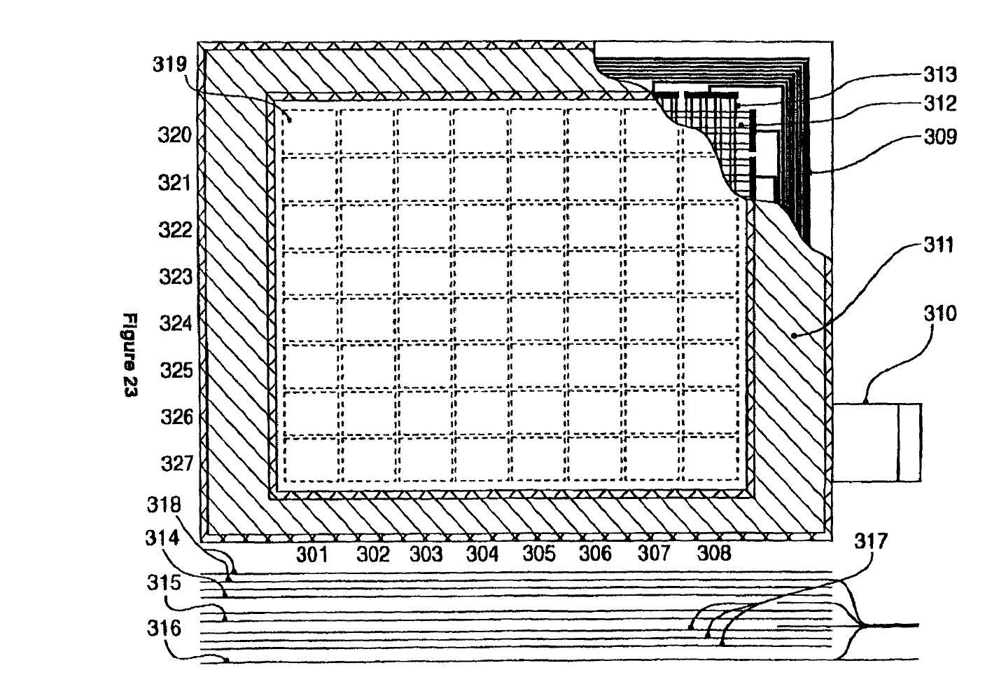

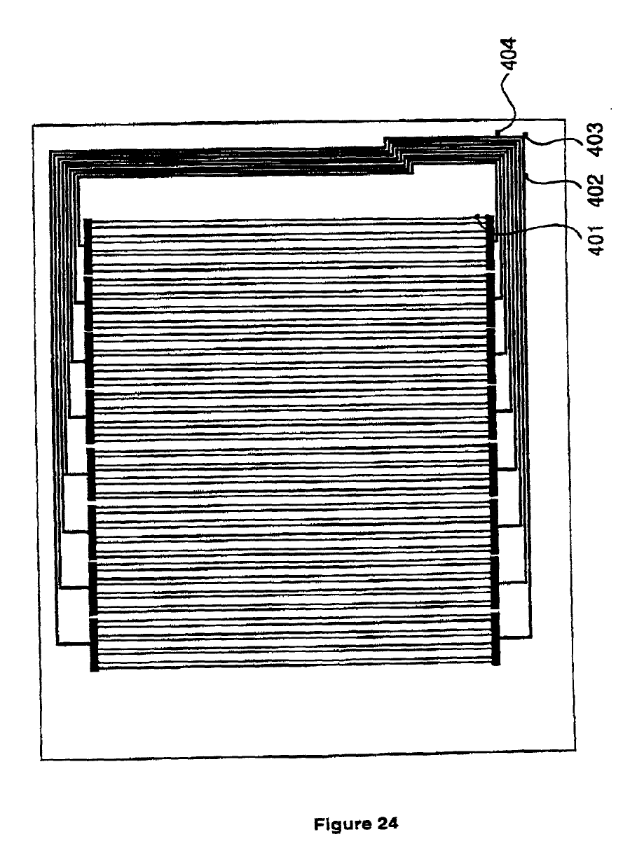

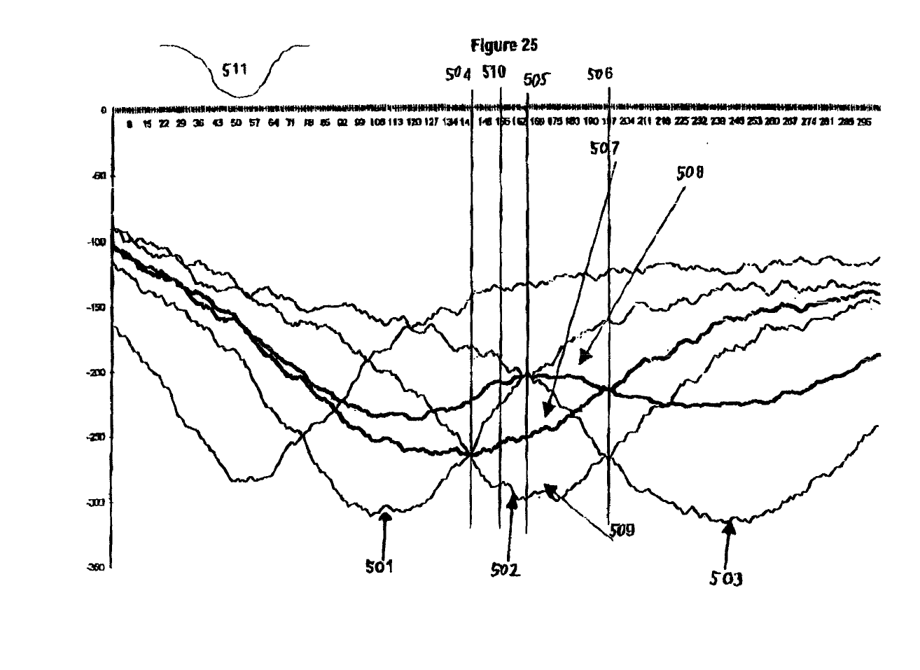

FIG. 22 shows the accumulator method in action. An accumulator is a memory element which holds the sum of the number input to it. While the rate of change of value of a particular wire is greater than a certain threshold this rate of change is added to its accumulator: portion 281 of the graph. When the rate of change drops below the threshold the accumulator is reset to zero: portion 282 of the graph. If the accumulator was greater than a certain level when it was reset to zero and it was the biggest accumulated value at that time then a touch down is reported, otherwise all accumulators continue to accumulate as before. If a second slightly higher threshold is exceeded then the delta values are weighted more greatly (typically doubled). Thus touch down is reported when:

1. The rate of change slows down (the finger is stopped by the glass.)

2. After there has been a substantial change in capacitance above the noise threshold. (The finger has moved in towards the glass rapidly.)

3. The wire which registered the sudden slow down registered the biggest reading at that time.

Note the accumulator registers nothing for lift off and so contains no information relating to the release.

FIG. 23 shows the general arrangement or a touch screen formed from two sets of 8 orthogonal capacitive zones formed by etching a transparent conductive sheet. These zones are labelled 301 to 308 and 327 to 320 in the Figure. The sheets are stacked in layers as follows: row layer 314, column layer 315, rear shield 316. The layers are glued together with additional stiffening layers 317 and printed graphics layers 318. Each capacitive sensor zone, for example the cross hatched zone marked 319, is formed from a number of thin strips shown at 312 & 313 (approx 5 mm wide) with gaps between (approx 5 mm wide), electrically connected together at each side of the screen and then to wires 309 which are formed from conductive silver track and lead back to an edge connector. A 16 channel capacitance measuring device (not shown) is connected to the edge connector. Since the aspect ratio of a television set or computer monitor is 4:3, the column zones are divided into four strips and the rows into three strips. This division ratio maintains constructional symmetry. The columns and rows are on separate sheets of material 314 & 315 and stacked together. The main reason for splitting the columns in thin strips is to provide gaps through which the row sensors can detect the finger. If the columns were not split up they would completely shield the rows and no information would be picked up. The rows are split simply to balance up the unetched area and therefore the capacitance of the rows and columns.

FIG. 24 shows the column layer alone.

FIG. 25 shows the data derived from a set of capacitive columns and used for applying linear interpolation. The graph represents the capacitance measured from a series of wires as a finger is moved from left to right across the screen. The X axis of the graph is time & distance, where each unit represents approximately 1/100th of a second or 0.25 mm. The Y axis gives a measure of the capacitance (measured by the 10 bit A/D converter of a microprocessor.) A series of 8 capacitive zones (columns) are represented as points upon the graph which form ‘bell’ curves as illustrated by 511 along with two averages 507 & 508 which form flattened bell curves.

Each capacitive zone increases its response as the finger moves from near it on one side, to dead centre, to far away (in the other side, in a curve 501-503 approximating an upturned bell curve as illustrated by 511. Due to the arrangement of the zones in close proximity to each other, these bell curves overlap one another. At a particular moment in time, placing a vertical line through the graph (vertical lines 504-506 & 510) gives the information known to the microprocessor at that time. Because the graph describes a finger swiped across the grid, each unit on the X axis not only represents a moment in time but also a distance.

The object is therefore to take a set of n data points (8 in this embodiment) at a moment in time and determine where they must come from in terms of the distance across the grid. The graph can be a little misleading in that normally time and distance are not synonymous. In general the touch is at some random time and we desire to determine the distance using only the 8 points from a particular slice of data,

There are two broad methods of doing this: either a pattern match to the nearest candidate among stored data or a geometrical method. The pattern match requires either a large data set or a neural network style approach, both of which are successful but computationally expensive. If the geometry of the object and sensor array are simple, then the geometrical method lends itself to implementation on a small microprocessor. In the case of an outstretched finger and an orthogonal rectangular array, the geometry is relatively straightforward. The geometrical method lends itself to being effective with little or no user calibration, so that effectively it is a self-calibrating method. Since the effective calibration operates for each press, it is effectively a dynamic self-calibration.

Take the existing graph as a representation of the effect on each wire at virtually every point across the grid. Now take n points of data from a vertical line chosen at random, the sample line 510 for example. The position determination and interpolation is performed in X & Y independently as follows.

1. The most pressed column 302 is found using the existing deltaT method (explained in relation to FIGS. 20-22). This places the touch at a position somewhere between positions 304 & 306, i.e when the value on wire 302 is largest.

2. The second most pressed column is then found by comparing the value on the wile adjacent in the most pressed column, i.e. the magnitude of the bell curves 501 & 503 at the intersection with sample line 510. This will put the touch point somewhere to the left or right of line 505. In this example the point must be to the left as 501 is greater than 503 at the intersection with the sample line 510.

3. The touch point is then known to be somewhere between the lines 504 and 505. These are the crossing points of curves 501 & 502 and curves 501 & 503 respectively. We compute the average magnitude of curves 501 & 502, giving curve 508, and the average magnitude of curves 501 & 503, giving curve 509. These curves are particularly useful because between the lines 504 & 505 the value on curve 501 is greater than the average 508 and less than the average 509, Also, at the line 514, the curve 501 is equal to curve 508 and at the line 505 the curve 501 is equal to curve 509.

4. The proportion of curve 501 relative to the two average curves 508 & 509 is therefore some function of the distance between the two lines 504 & 505. This function can be determined either experimentally, and then programmed into a look up table, or mathematically, and then applied to the raw data to compute the position, At a first pass, a linear relationship generates a reasonable interpolation of position with some improvement generated by using a quadratic function or a series of straight line segments approximating a quadratic function.

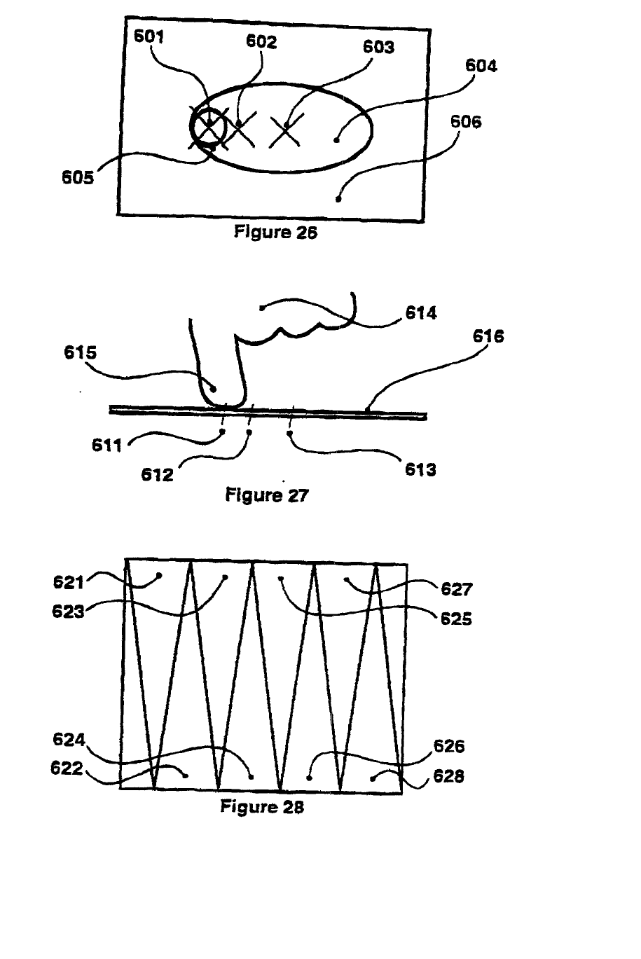

FIGS. 26 and 27 show in plan and elevation a hand 604 with outstretched finger 605 on a touch screen 606 and the apparent positions calculated by two algorithms—geometric 602 and weighted mean 603. With the palm and knuckles a long distance back from the screen, both algorithms give similar touch coordinates near to point 601. When significant palm effect is introduced (the hand brought very close to the screen as the screen is touched), the geometric algorithm moves about 5%, i.e. to point 602. The centre-of-mass algorithm gives a bigger offset moving to point 603 for the same degree of palm introduction. Thus, by calculating the difference between these two calculated positions 602 & 603, an estimate of the true touch position 601 is obtained. Means effecting this calculation thus serve for palm rejection.

FIG. 28 is a diagram of a single surface asymmetrical sensor arrangement ‘backgammon grid’. The single conductive surface represented by the rectangle is cut into a series of triangles by cut lines across the surface. Thus, the surface is cut into areas 621-628. Position in X can be determined by considering sensor zones 621-622, 623-624 etc as a single approximately rectangular zone and using interpolation as described before to determine position. Position in Y can be determined by comparing the effect between even numbered and odd numbered zones. Errors are introduced by the complex geometry of the grid and an iterative approach is required to find an accurate position on the grid.

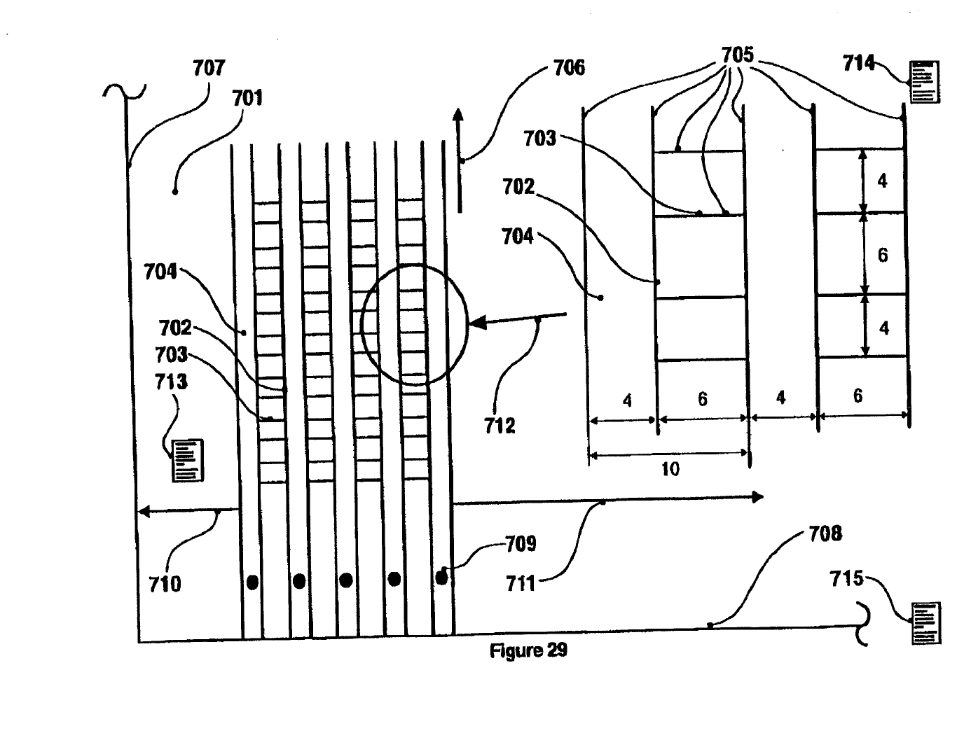

FIG. 29 is a drawing showing a general arrangement for laser etching the coating from electrically conductive glass 701 to form the column layer as described in relation to FIG. 24 without introducing unwanted capacitive coupling. In the FIG. 24 arrangement, the gaps in between lines were chemically etched to remove the entire material and provide holes for the rows to sense through. The preferred glasses for construction are not easily chemically etched and so a laser is used. A laser is unable to remove large areas, being fundamentally designed to cut lines. The gaps between sensors are first cut away with long lines 702. Although this removes them from the general material of the front sensor it leaves long floating strips of material which tend to couple all the row sensors together. These rectangles are therefore further cut by making cross cuts 703. Thus, although the rows capacitively couple to these small areas, they do not then couple to other rows, and crosstalk is kept to an acceptable level.

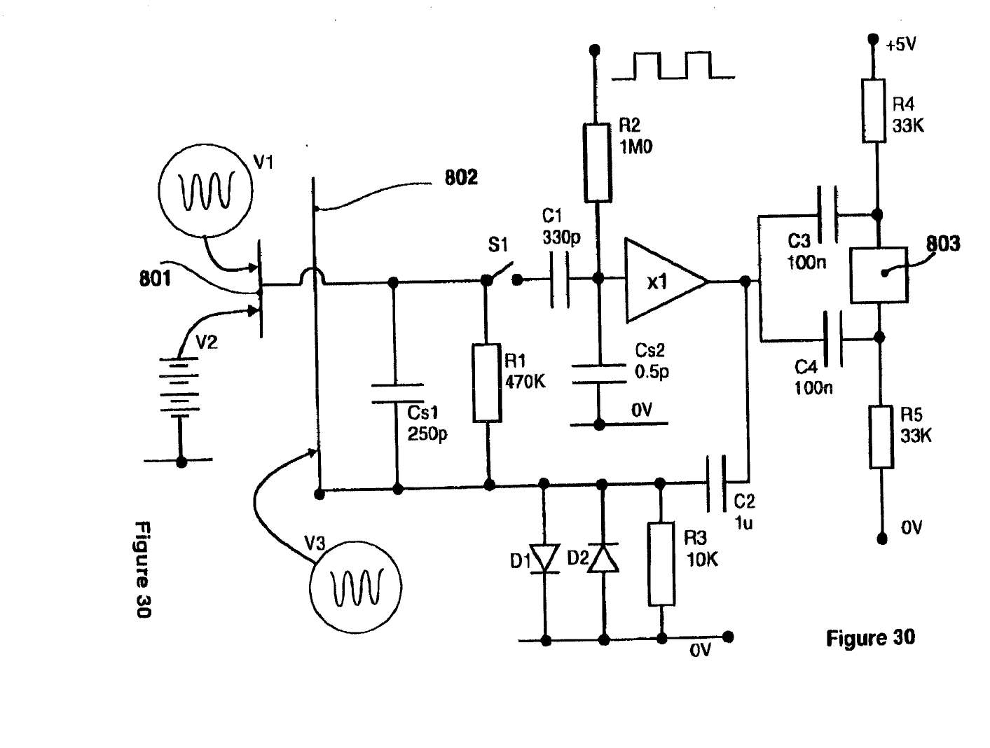

FIG. 30 is the circuit diagram of an improved capacitance detection means more able to differentiate noise. A capacitive sensing plate 801 and buffer plate 802 are set to measure the capacitance of a finger. Noise sources V1, V2 & V3 impinge upon these plates erroneously triggering the detection means. A number of beneficial modifications have been made compared with the circuits disclosed in previous patents to limit the excursions of the circuit due to these noise sources. D1, D2 & R3 form a clipping circuit which limits the voltage excursions on the buffer to one diode drop of the mean point. Thus the energy content of high voltage static spikes and monitor noise impinging upon the sensor or buffer are dramatically reduced, Resistors R1 & R3 provide a DC path through which static on the sensor plate 801 can be continuously discharged to ground 0V regardless of the state of the switch S1. In a scanning system, static charge building up on the sensor plate 801 which is able to overcome the bleed-off resistor R1 is connected into the buffer from time to time via a voltage controller switch S1 which is an integral part of the multiplexer 803 (MUX). Capacitors C1 & C2 provide a block to this charge, thus avoiding any disturbance of the DC operating point of the buffer X1. In this circuit, the buffer is capacitively coupled to the sensor plate 801 (and into the detector generally) and thus makes no attempt to follow any DC or low frequency excursion of the buffer. This makes the circuit intrinsically immune to noise away from the operating frequency.

The main differences between these techniques and the prior art are:

Detecting and responding to touch using signal processing means so arranged as to differentiate between an unwanted signal and a touch caused by a user with output means so arranged as to give immediate video and/or audio tactile feedback. Said signal processing means comprising: a detector sensitive to changes in the capacitance of a sensor by detecting the current/voltage/phase change across an impedance connected to a varying signal, and the signal present on the sensor feed back through a finite frequency response buffer amplifier to one or more shield planes including the substrates of any chips within the sensing chain.

Signal processing means so arranged as to differentiate between a deliberate touch and noise or an unwanted touch by reference to many sensors.

Signal processing means so arranged as to differentiate between a deliberate touch and noise or an unwanted touch by reference to the capacitive analogue of the distance, speed and acceleration of the touching object.

Signal processing means so arranged as to immediately, within <50 mS, indicate to the user the detection of their touch via the flashing or turning on of a light or similar optical change through the touch detection sensor.

Artwork and detection means placed behind a window and so designed as to present the user with one or more touch zones which are operable through that window and upon touching cause a reaction.

One or more sensitive pads connected via shielding means to a control means which detects the touch of a human finger on the pad through that window and via the control means generates an electrical signal which can operate equipment.

Same where the pad is made from transparent material so that the artwork can be backlit through the pad or so that an image can be seen through the pad.

Same where the pad is made from a translucent and optionally coloured material that provides a degree of light diffusion such that the back light is evenly distributed across the artwork.

Same where the pad is made from a grid or mesh of conductive elements such that it is partially transparent/translucent.

Same where the controlling electronics is implemented by utilising a means of applying an oscillating signal of a particular frequency onto a plate via a high value resistor and monitoring the signal after the high value resistance with an amplifier and synchronous AM demodulator.

Same where the amplifier means provides a buffering signal which varies in synchronisation with the sensor signal and is applied to a number of guards.

Same where the guard element includes a multiplexing element.

Same where that multiplexing element is controlled by way of a level translator means such that the buffer is always operating within it design parameters.

Same where a plurality of multiplexers is connected in series such that each multiplexer is buffered.

A system so arranged that multiplexers are controlled through a serial interface such that an interposed serial to parallel decoder determines which multiplexer line is connected to the sensor input.

Same in which coaxial cable and coaxial connectors are used throughout to provide the shielded means of collecting signals from the sensors.

Same where a high value resistor is placed front the sensor to a low impedance point in the circuit so that static accumulating on a sensor can find a path to ground.

A mean for detecting a touch on a surface connected to a means of generating vibration on said surface such that that vibration provides tactile and optionally audio feedback.

A plurality of capacitive proximity sensing elements connected to control means such that the position of a finger over a surface can be determined in 2 or more dimensions.

Same arranged as an X, Y grid such that the intermediate position of a finger between two or more elements can be determined in the X and Y dimensions.

Capacitive elements arranged as a “String on beads” such that each capacitive sensing element comprises a pad connected to the previous pad by way of a resistor.

A capacitive element where the capacitance and resistance are distributed rather than formed from lumped elements.

A system as claimed in claim 1 wherein a record is kept of the maximum sensed value of a press among the last n presses (the number n of presses being chosen for optional operating conditions, typically the last 128 presses) and this is used to alter dynamically the sensitivity to touch. Preferably, there is also a reset feature for this, so as to adapt the sensitivity to each operator, for example automatic, e.g. responsive an interval between presses longer than usual (or longer than a preset time), or a change in one or more characteristics of the press, e.g. absolute capacitance and/or geometrical area of effect of the press.

Same where the rate of change (derivative) of the sensed value is used to determine the point of touch. (Uses the dielectric discontinuity theory.)

A control means so programmed as to differentiate between a deliberate touch and an accidental touch or other interfering electrical signal using information from one or more untouched keys and the knowledge of the initial conditions of the system.

A control means programmed to monitor the initial condition and sensitivity of each sensor and detect variations from those initial conditions by utilising a non-linear equation with reference to the initial conditions parameter and so normalising variations in sensitivity between differing sensor channels.

KEY

In the drawings, text corresponding to Figure references is as follows:

FIG. 1:

101 Display Artwork

102 Touch Pads

103 Window

104 Controller

105 Connection to Computer

FIG. 2:

106 Control

107 OSC

108 Flip/Flop

109 x1

110 Phase Delay

111 xN

114 ADC INPUT

115 MUX

116 MUX

119 LOGIC

FIG. 3:

130 A

131 B

FIG 4:

132 Distance

133 Time

134 Press

135 Hold

136 Release

137 Liftoff

138 Baseline

139 Maximum Press

140 Capacitance Rising

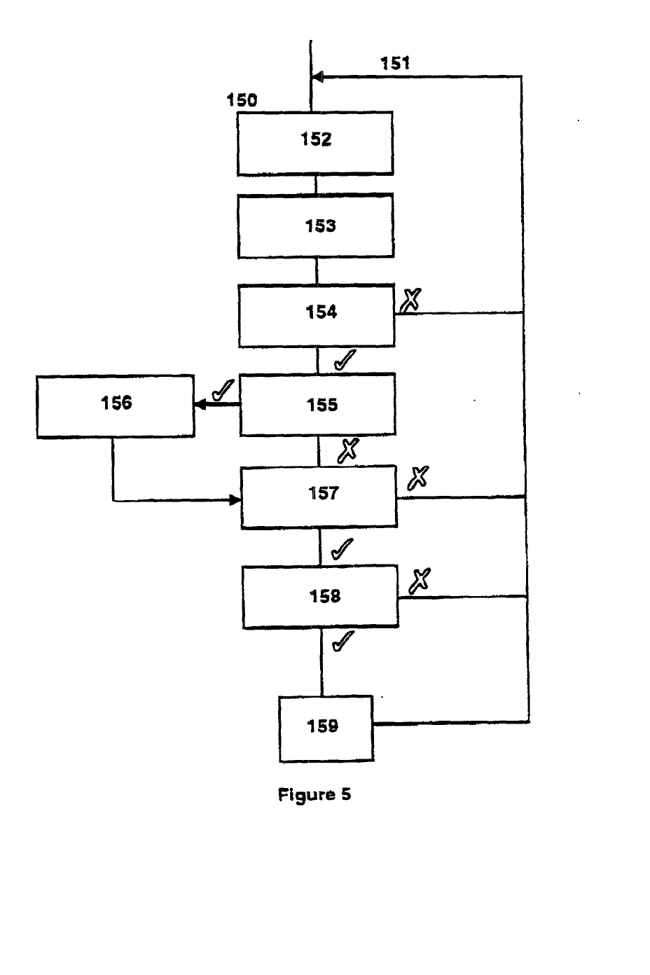

FIG. 5:

150 For each key

151 Do not key

152 Select key

153 Get Press Value

154 Over Threshold

155 Static Detect

156 Delay

157 Keypress Detected Once Before?

158 Mode Check OK?

159 PRESS DETECTED

FIG. 6:

161 Centre Wire

162 Frit

163 Glass

164 Braid

165 Coax

FIG. 7:

171 Finger

172 Glass layer

173 PCB Substrate

174 Sensors detect finger at differential ranges

175 Sensor plates

FIG 8

181 Finger

182 (=glass thickness)

FIG 9:

191 Finger tip slides over surface

FIG. 10:

201 MUX

FIG 11:

211 finger

212 sensors

FIG. 13:

221 Buffer

222 High Impedance Input

223 Low Impedance Output

224 Virtual Ground

225 Sensor

226 Incident RF Wave

FIG. 14:

231 Large

232 4 mm

233 1 mm

FIG. 15:

241 Equipotential

242 0 Volts

243 Field Line

FIG. 16:

251 Human

252 Hand

253 Sensor

254 Earth

255 Ground

FIG. 19:

261 RES

262 OSC

FIG. 24:

401 ITO

402 AG REF

403 AG TRIM

404 AG

FIG. 29:

705 CUT LINES

706 EXTEND TO EDGE

707 EDGE OF GLASS

708 EDGE OF GLASS

709 PADS OF FRIT

710 REPEAT

711 REPEAT TO EDGE

712 (Symbol indicating magnification of part of main drawing)

713 [Repeat ‘snip’ lines to edge]

714 [Material: Single-side coated 15 ohm ‘K’ as supplied by LOF]

715 [Top conductive layer

Notes

1. Sensor lines are 4 mm wide separated by 4 mm gap

2. The gap between sensors is further cut up into small areas—the cut lines correspond to the sensor cut lines on the layer below

3. All sensor lines are separate. The frit pads are used to common up and connect to controller.

4. Glass area can be completely covered with pattern.

5. A border may be left uncut if desired—but should by isolated with cut from rest of pattern.]

FIG. 30:

803 MUX

It will be apparent to one skilled in the art, that features of the different embodiments disclosed herein may be omitted, selected, combined or exchanged and the invention is considered to extend to any new and inventive feature or combination thus formed.

It will be apparent to one skilled in the art, that features of the different embodiments disclosed herein and by importation from the aforementioned prior patents and application may be omitted, selected, combined or exchanged and the invention is considered to extend to any new and inventive combination thus formed.

1. A capacitive detector, which comprises means to recognise a profile of capacitance change indicative of a touch to be detected.

2. A detector as claimed in claim 1, which is adapted to detect the instant and position of a touch.

3. A detector as claimed in claim 1, which is adapted to detect a touch by sensing a rapid or sudden rise in capacitance at touch down between a touch member, e.g. a finger, and a member of the detector, e.g. a dielectric plate, or an interposing dielectric, which may be called a snap effect.

4. A detector as claimed in claim 1, which is adapted to detect a touch by means of sensing a rapid rise in capacitance as a touching member, e.g. a finger, is squashed, flattened or compressed by being pressed against a detector plate or interposing dielectric.

5. A detector as claimed in claim 1, which comprises a plurality of sensing elements each adapted to detect the touch, and means adapted to determine by means of inputs from the elements and an interpolation algorithm the accurate position of a touching member, e.g. a finger.

6. A detector as claimed in claim 5, which comprises it first said plurality of sensing elements and orthogonally to these a second said plurality of sensing elements.

7. A detector as claimed in claim 5, wherein the determining means comprise means adapted to allow for the shape of a touching member and/or of a detector member.

8. A detector as claimed in claim 5, which comprises means to effect the determination with the aid of a quadratic.

9. A detector as claimed in claim 5, which comprises means to effect the determination with the aid of inputs from three sensing elements and the spacing between the elements.

10. A detector as claimed in claim 5, which comprises means to effect the determination with the aid of a self-calibrating method.

11. A detector as claimed in claim 1, which comprises means to effect the determination with the aid of a snap effect algorithm.

12. A detector as claimed in claim 1, which comprises means to effect the determination with the aid of a differential algorithm.

13. A detector as claimed in claim 1, which comprises one or more sensor elements formed from conductively coated glass by selectively removing the coating from the glass.

14. A detector as claimed in claim 13, which comprises sensor elements formed from conductively coated glass by selectively removing the coating from the glass to form orthogonal sensor elements capable respectively of detecting the X and Y position of a touching member.

15. A detector as claimed in claim 1, which comprises an accumulator.

16. A detector as claimed in claim 15, which is adapted to ensure that while the rate of change of value of a particular input is greater than a certain threshold increments representing this rate of change are added to the accumulator.

17. A detector as claimed in claim 16, which is adapted to ensure that when the rate of change drops below the threshold the accumulator is reset to zero.

18. A capacitive detector, which comprises an accumulator.

19. A screen for a capacitive detector, which comprises one or more sensor elements formed from conductively coated glass by selectively removing the coating from the glass.

20. A screen as claimed in claim 19, which comprises sensor elements formed from conductively coated glass by selectively removing the coating from the glass to form orthogonal sensor elements.
